(19) United States
(12) Patent Application Publication
(10) Pub. No.: US 2015/0080075 A1
(43) Pub. Date: Mar. 19, 2015

(54) Systems And Methods For Playing A Treasure Hunting Board And Video Game

(71) Applicants: Susan Schlereth, St. Charles, MO (US); Tommy Schlereth, St. Charles, MO (US)

(72) Inventors: Susan Schlereth, St. Charles, MO (US); Tommy Schlereth, St. Charles, MO (US)

(21) Appl. No.: 14/555,189

(22) Filed: Nov. 26, 2014

Related U.S. Application Data
(63) Continuation-in-part of application No. 14/257,247, filed on Apr. 21, 2014.
Application No. 14/257,247 is a continuation-in-part of application No. 14/213,295, filed on Mar. 14, 2014.
(60) Provisional application No. 61/791,686, filed on Mar. 15, 2013.

(51) Int. Cl. A63F 13/822; A63F 13/33; A63F 13/87

(52) U.S. Cl. CPC A63F 13/822; A63F 13/87; A63F 13/33
USPC 463/10

(57) ABSTRACT

An on-line, persistent multiplayer video game wherein players compete to secure the best bargains at garage sales, using both strategy and random chance.

### CROSS REFERENCE TO RELATED APPLICATIONS

This application is a Continuation-in-Part of United States Utility patent application Ser. No. 14/257,247 filed Apr. 21, 2014, which is Continuation-in-Part of United States Utility patent application Ser. No. 14/213,295 filed Mar. 14, 2014, which claims benefit of U.S. Provisional Patent Application No. 61/791,686 filed Mar. 15, 2013. The entire disclosure of the above applications are incorporated herein by reference.

### BACKGROUND

1. Field of the Invention

This disclosure is related to the field of entertainment gaming, specifically to board and video games which simulate modern-day treasuring hunting, including but not limited to estate sales, garage sales, yard sales, rummage sales, public auctions, and the like.

2. Description of the Related Art

Recently, television programs featuring competitive treasure hunting have grown in popularity. These programs commonly feature locales such as pawn shops, antique shops, abandoned storage lockers, attic sales, and the like, in which people try to buy or sell hidden treasures. Perhaps not coincidentally, the American tradition of the garage sale, sometimes also called a yard sale or rummage sale, has also grown. These sales give weight to the adage, “one man's trash is another man's treasure,” as homeowners cleanse their basements and garages of unwanted merchandise by selling it at bargain prices.

These sales are often held just before a move. Enterprising sellers advertise their sales to maximize the turnout of buyers, and enterprising buyers meticulously plan their weekends of treasure hunting, sometimes going so far as to camp out before a sale opens. It is well-known among regulars that garage sales are quickly picked over, and to be early is to have the best chance of scoring the best bargains and getting the highest value items for the least cost. So widespread is the American tradition of the garage sale that books are published advising both sellers and buyers on how best to maximize their gains.

Garage sale treasure hunting has evolved into a form of entertainment, as evidenced by the abundance of TV shows capitalizing on the entertainment value inherent in scoring a great deal. Despite the popularity of this hobby, there are few board games premised upon treasure hunting at garage sales, and there appear to be no board games that simulate competitive treasure hunting at such sales.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is a system for hosting an playable on-line video game simulating competitive treasure hunting comprising: a computer server communicating with a client device over a network and comprising: a processor; a tangible non-transitory computer-readable storage medium having computer-readable instructions which, when executed by the processor, cause the computer server to provide on the network a service implementing a plurality of game elements which, together, comprise an on-line, persistent, multiplayer competitive treasure hunting video game, the plurality of game elements comprising: a plurality of player position tokens; a game board comprising: a plurality of paths divided into a plurality of landable spaces; a plurality of purchasing locations each connected to one of the landable spaces; a plurality of merchandise indicators having and associated merchandise purchasable at one of the plurality of purchasing locations associated with the indicator when the game is played and an associated cost of the merchandise and an associated worth of the merchandise; an in-game currency; a movement limitation mechanism; a merchandise display mechanism; a merchandise appraisal mechanism; a reward system incentivizing players playing the board game to acquire a plurality of the plurality of merchandise cards such that the player maximizes the total amount of worth indicated on the plurality of the plurality of merchandise cards acquired by the player; when a plurality of players play the game, a plurality of the plurality of merchandise cards corresponding in number to the plurality of players is associated with each one of the purchasing locations; and when each player in the plurality of players advances one of the player tokens corresponding to the each player to a purchasing location in the plurality of purchasing locations, the each player may exchange for one of the plurality of the plurality of merchandise cards placed associated with the each purchasing location an amount of the game currency held by the each player equal to the cost of the merchandise indicated on the one of the plurality of the plurality of merchandise cards associated with the each purchasing location.

In an embodiment, the associated cost of the merchandise is a pseudo-randomly generated value.

In another embodiment, the associated cost of the merchandise is a pre-determined value.

In another embodiment, the associated worth of the merchandise is a pseudo-randomly generated value.

In another embodiment, the associated worth of the merchandise is a pre-determined value.

Also described herein, among other things, is a method for implementing an on-line, multiplayer, persistent video game on a computer server having a processor and a tangible, non-transitory computer-readable storage medium and the capability of communicating with a client device, the method comprising the steps of: providing a plurality of player position tokens; providing a game board including: a plurality of roads divided into a plurality of landable spaces; a plurality of residences each connected to one of the landable spaces; providing a plurality of merchandise indicators having and associated merchandise purchasable at one of the plurality of residences associated with the indicator when the game is played and an associated cost of the merchandise and an associated worth of the merchandise; providing a game currency; providing a pseudorandom number generator; providing a plurality of players; providing a reward system; providing a merchandise display mechanism; providing a merchandise appraisal mechanism; each player in the plurality of players moving a player position token representing the each player a number of the landable spaces corresponding to a pseudorandom numeric value determined using the pseudorandom number generator until the player position token is at one of the plurality of residences; appraising a merchandise with the merchandise appraisal mechanism; display a merchandise with the merchandise display mechanism; when the player position token is at the one of the plurality of residences, the each player exchanging for one of the plurality of merchandise cards disposed at the one of the plurality of residences an amount of the game currency held by the each player equal to the cost indicated on the one of the plurality of merchandise cards; the reward system incentivizing the players playing the game to acquire a plurality of the plurality of merchandise cards such that the player maximizes the total amount of worth indicated on the plurality of the plurality of merchandise cards acquired by the player.

In an embodiment, the associated cost of the merchandise is a pseudo-randomly generated value.

In another embodiment, the associated cost of the merchandise is a pre-determined value.

In another embodiment, the associated worth of the merchandise is a pseudo-randomly generated value.

In another embodiment, wherein the associated worth of the merchandise is a pre-determined value.

### BRIEF DESCRIPTION OF THE DRAWINGS

FIG. 1 depicts a layout of an embodiment of the game with a detailed view of a sale card.

FIG. 2 depicts a detailed view of a portion of an embodiment of a game board.

FIGS. 3A-3I depict a portion of an embodiment of a game board.

FIG. 4A depicts an embodiment of a merchandise card having a numeric indication of worth.

FIG. 4B depicts an embodiment of a merchandise card having a scannable code indication of worth.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Throughout this disclosure, the term “computer” describes hardware which generally implements functionality provided by digital computing technology, particularly computing functionality associated with processors and microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, and mainframe computers.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include, but are not limited to, network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable binary files, object code, compiled libraries, implementations, algorithms, or any instruction or set of instructions capable of being executed by a computer processor, or capable of being converted into a form capable of being executed by a computer processor, including, without limitation, virtual processors, or by the use of run-time environments or virtual machines. Those of ordinary skill in the art recognize that software can be wired directly onto hardware, including, without limitation, onto a microchip, and still be considered “software” within the meaning of this disclosure. For purposes of this disclosure, software includes, without limitation, instructions stored or storable in any form of memory device, including RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described herein are contemplated to use computers and computer software typically stored in a non-transitory computer- or machine-readable media or memory.

Throughout this disclosure, terms used herein to describe or reference media holding software, including, without limitation, terms such as “media,” “storage media,” and “memory,” may include both transitory media such as signals and carrier waves and non-transitory media.

Throughout this disclosure, the term “network” refers to any data or telecommunications network over which computers communicate with each other. The term “server” generally means a computer providing a service over a network, and a “client” generally means a computer accessing or using a service provided by a server over a network. Those having ordinary skill in the art will appreciate the terms “server” and “client” may refer to hardware, software, and/or a combination of a hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network, or may, in verb form, refer to a server providing a service over a network, or an access point for a service over a network.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

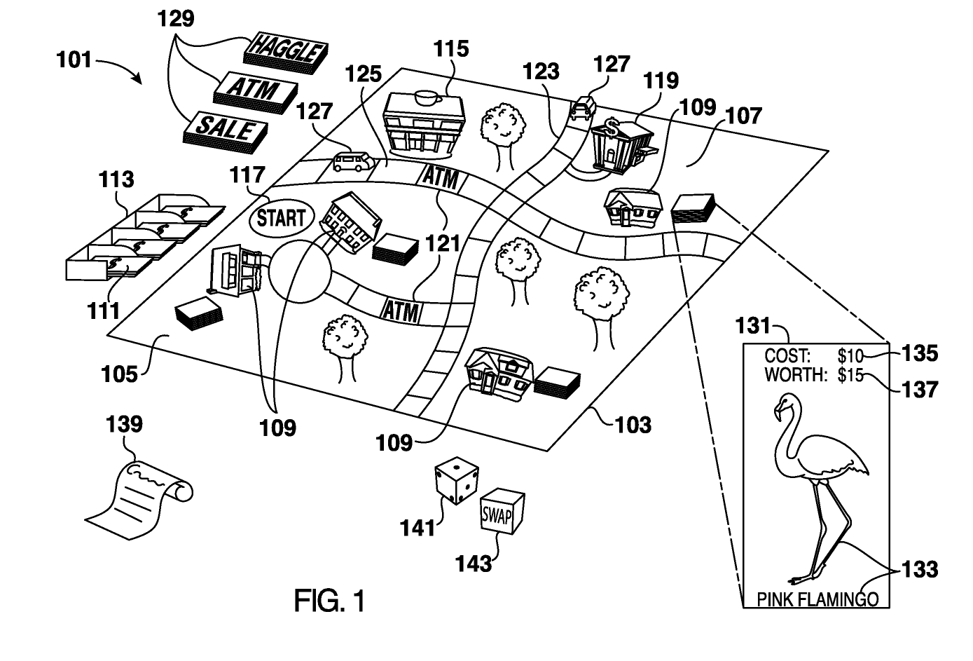

Generally, this disclosure describes a board game, but it is specifically contemplated that the board game described herein may also include video game components. An embodiment of a treasure hunting game is depicted in FIG. 1. In the depicted embodiment of FIG. 1, players compete with each other to accumulate goods having the highest worth at various sales. Generally, each player on his turn navigates through a neighborhood (107) depicted on a game board (103) by advancing a token (127), representing the player, a pseudo-randomly generated number of spaces (125) along paths (123) on the game board (103) until the token arrives at various residences (109) depicted on the game board (103). The player purchases one item for sale at each residence (109) by exchanging an amount of a simulated game currency (111) for a card (131) indicating the item purchased and its worth (137). After the player has purchased an item at each residence (109), the player navigates to a final position (115), such as a coffee shop (115). When all players have concluded their purchases, the player who has acquired the goods whose total worth (137) indicated on the cards is highest is deemed the victor.

Generally speaking, the game (101) includes a game board (103), one or more decks of cards (129), a set of tokens (127) representing the players, a set of game currency (111) comprising sets of bills or notes in different denominations, a set of “Classified Ad” slips (139), and one or more dice (141 and 143). Generally, an organizational tray (113) for these and other components is also included. This tray (113) both stores and organizes game currency (111) during play and also stores the game (101) components when the game (101) is stored and not in use, as well as stores components not used while the game (101) is being played.

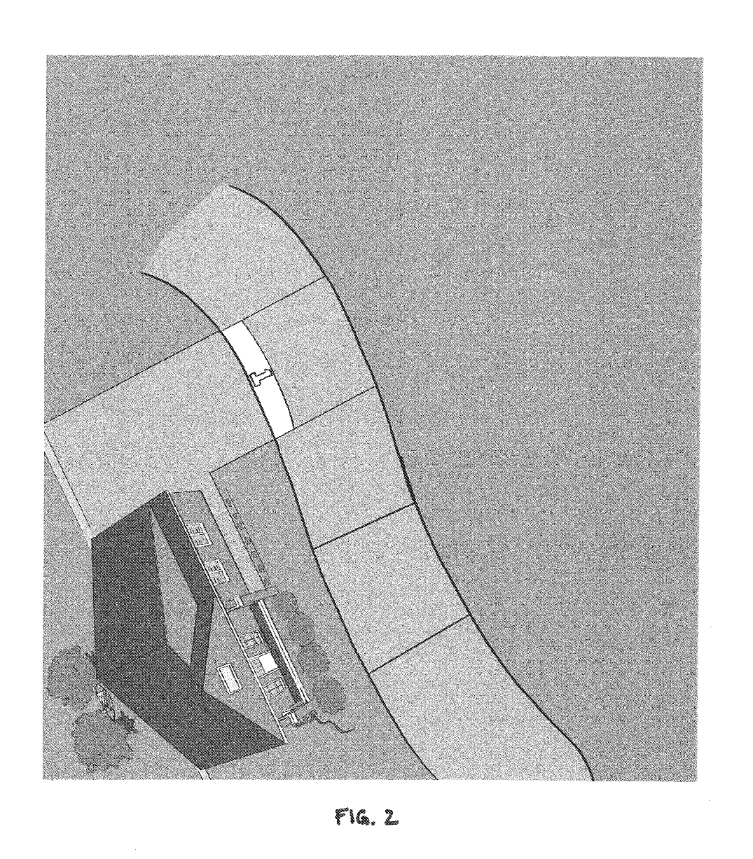

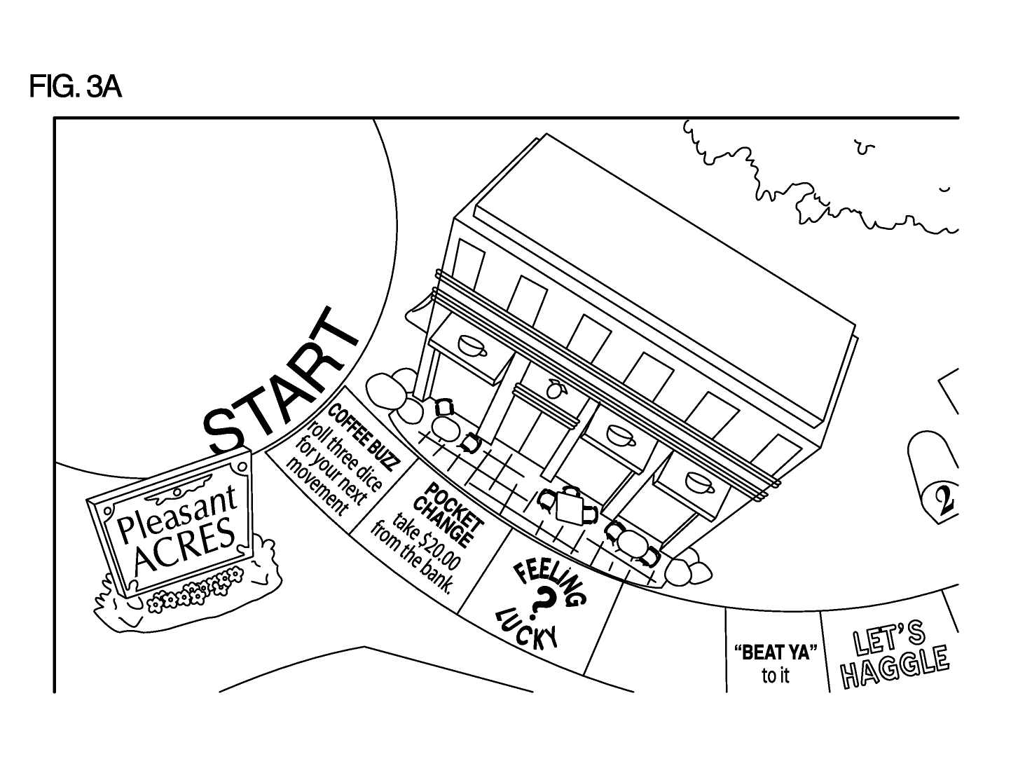

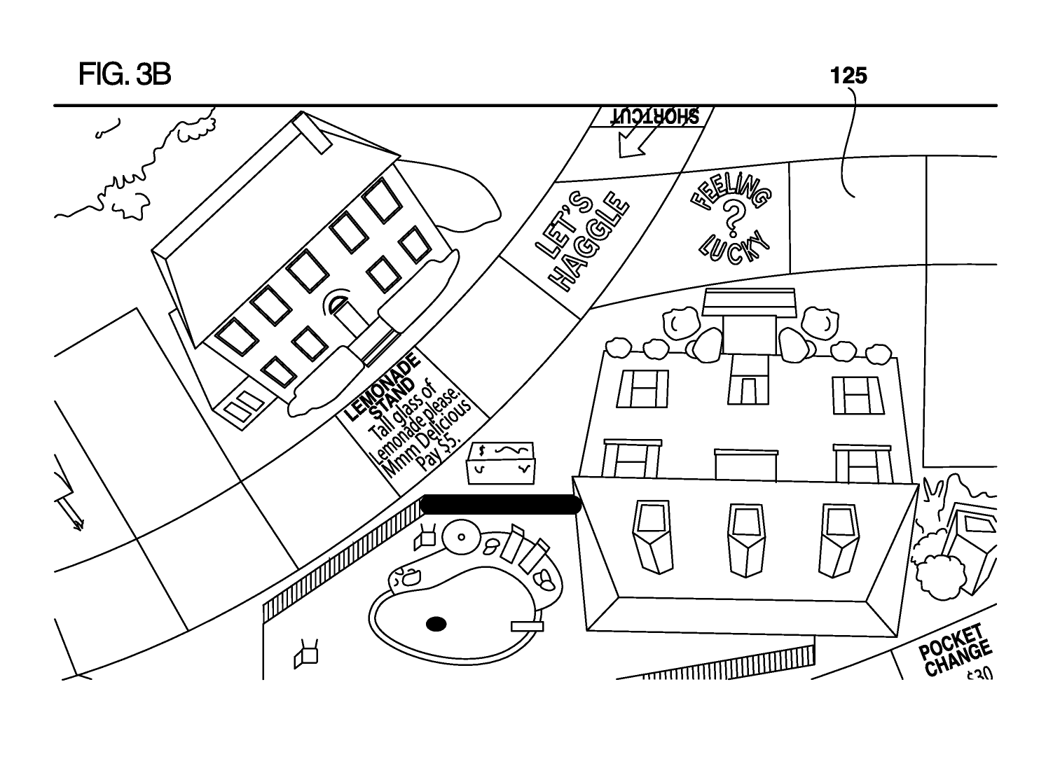

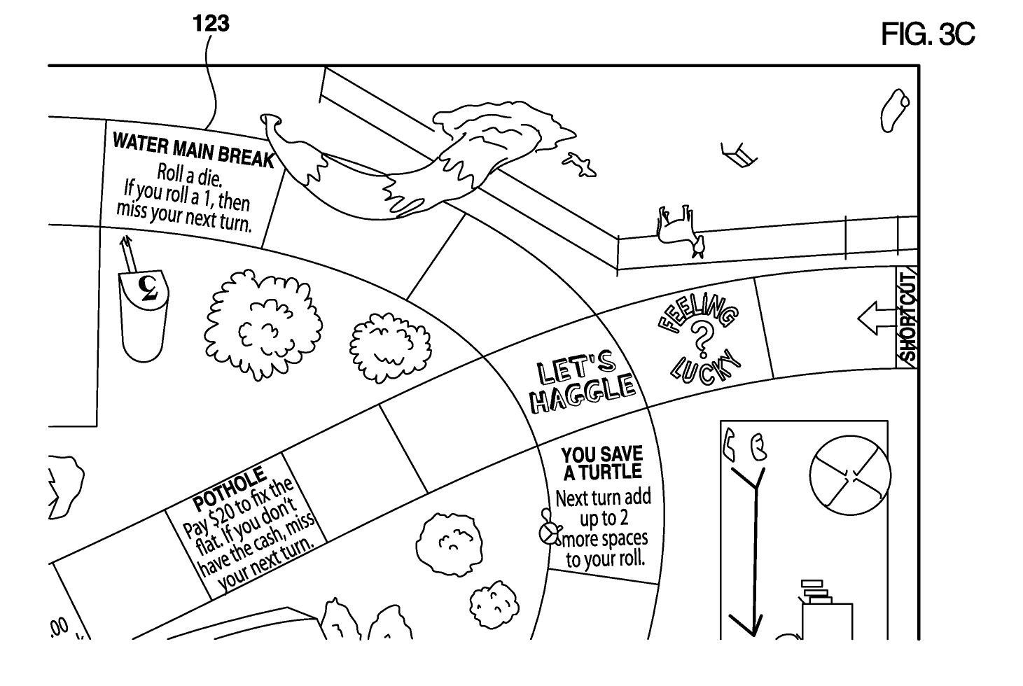

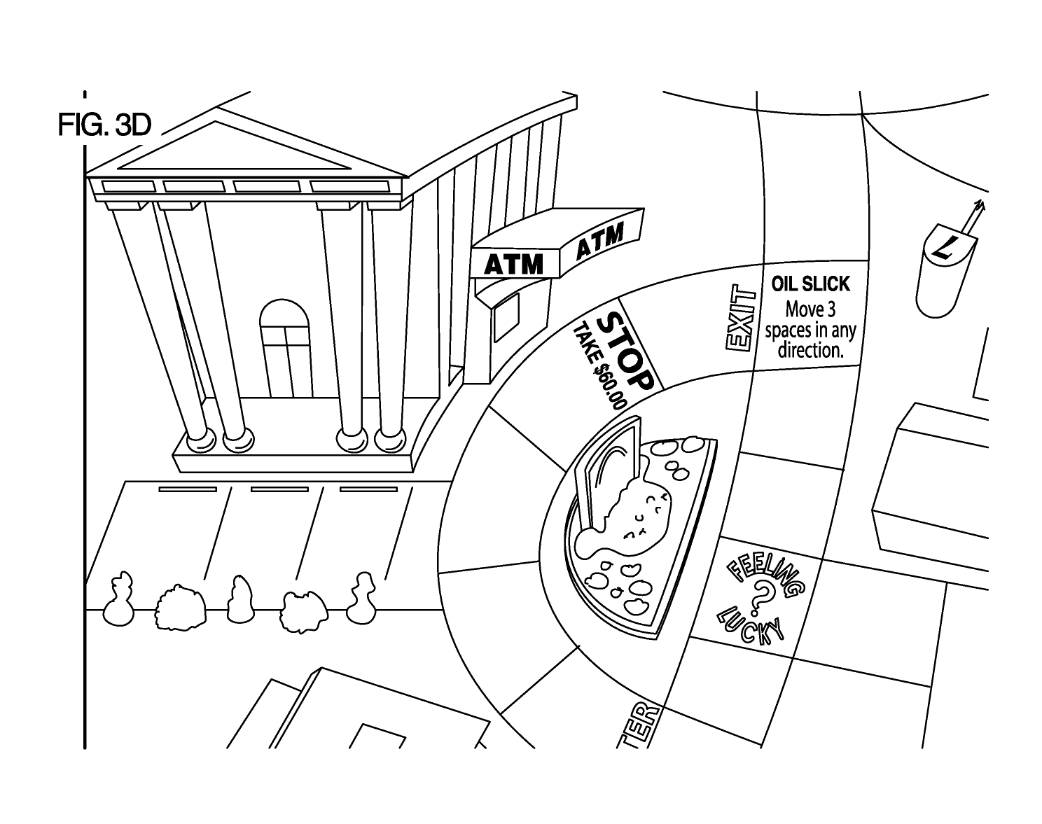

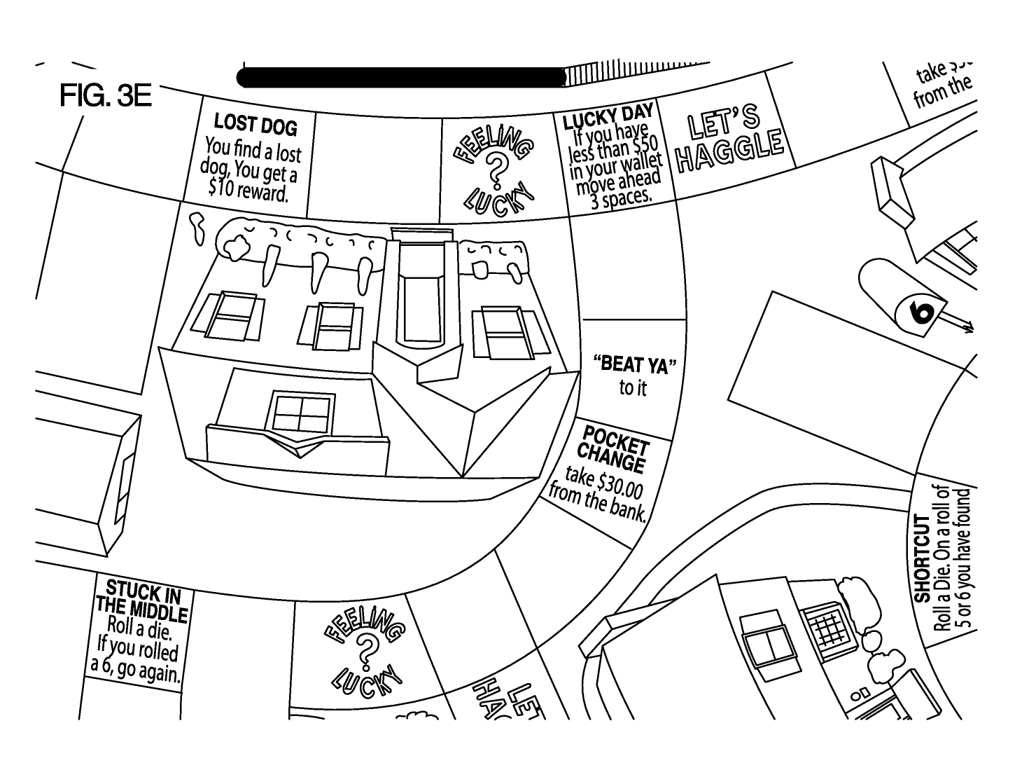

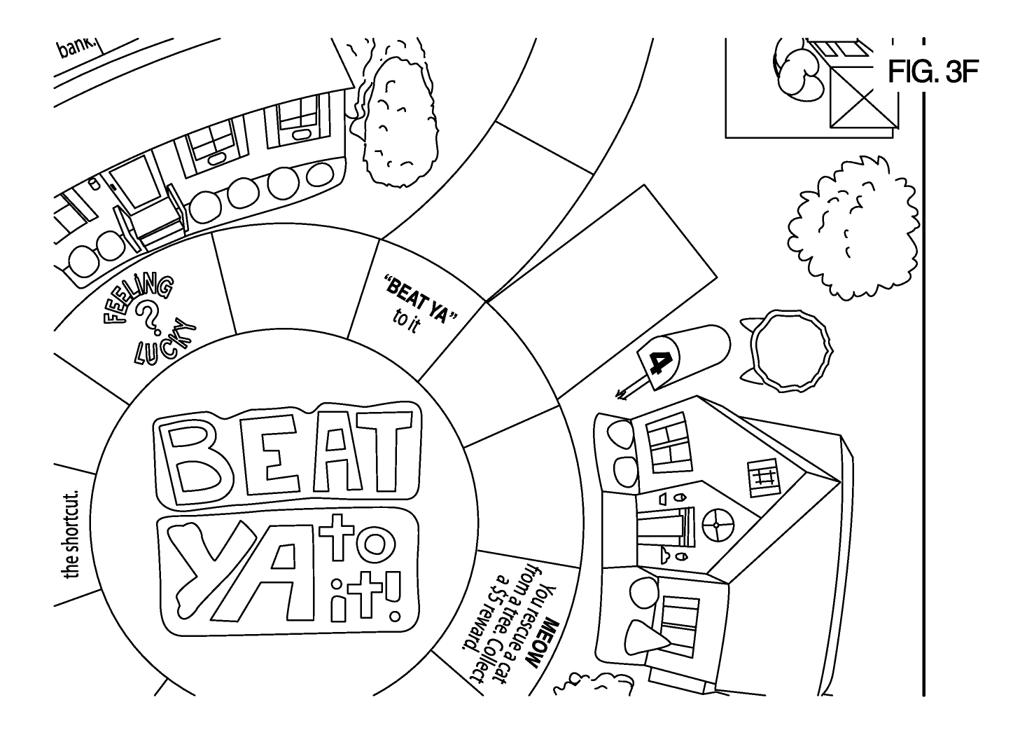

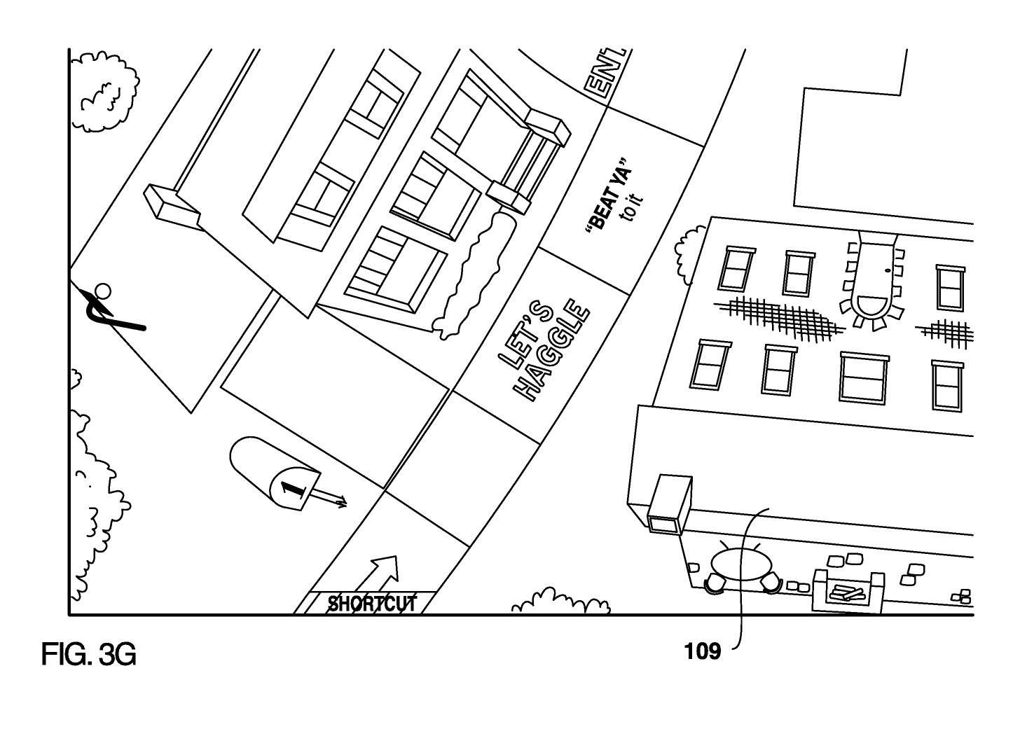

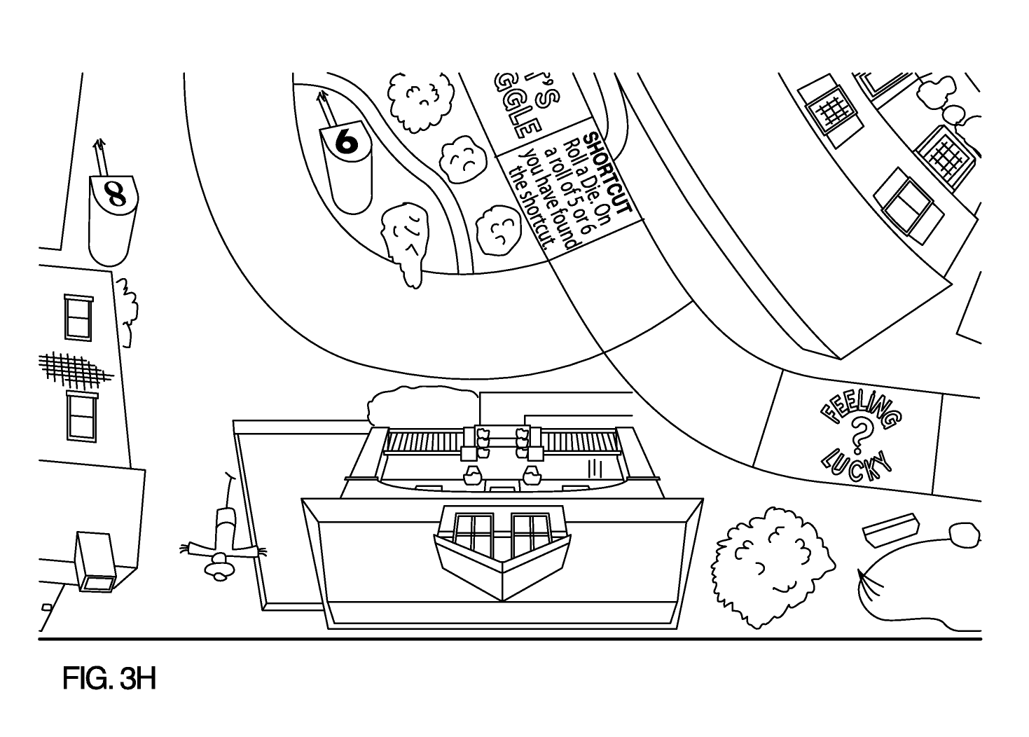

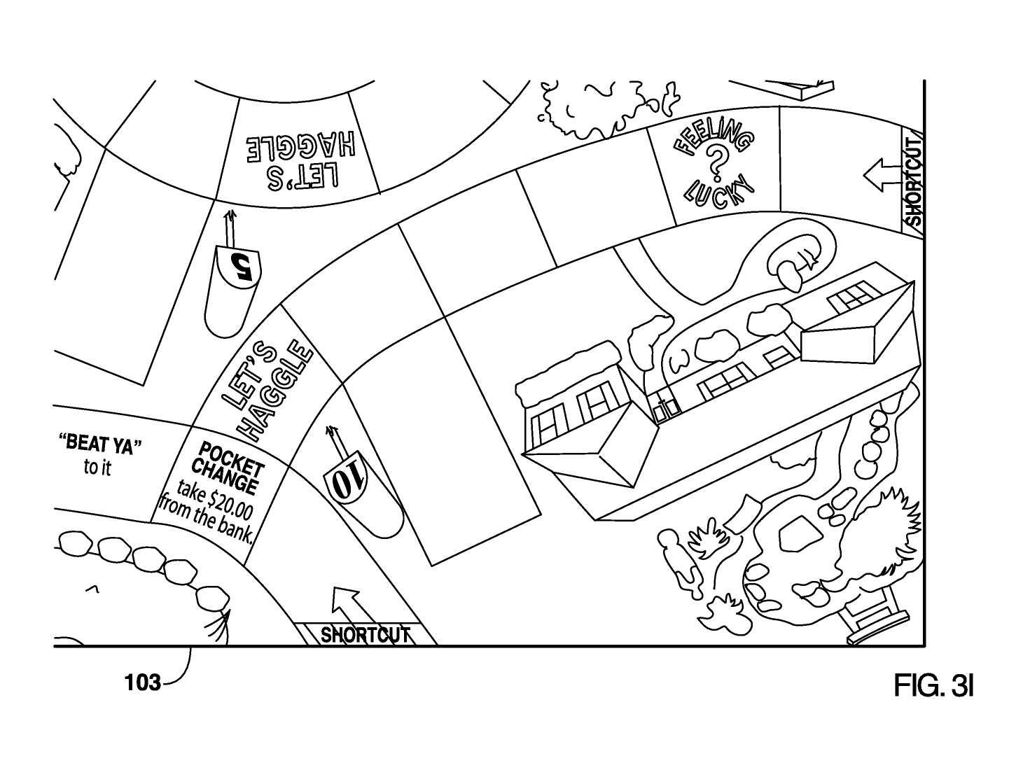

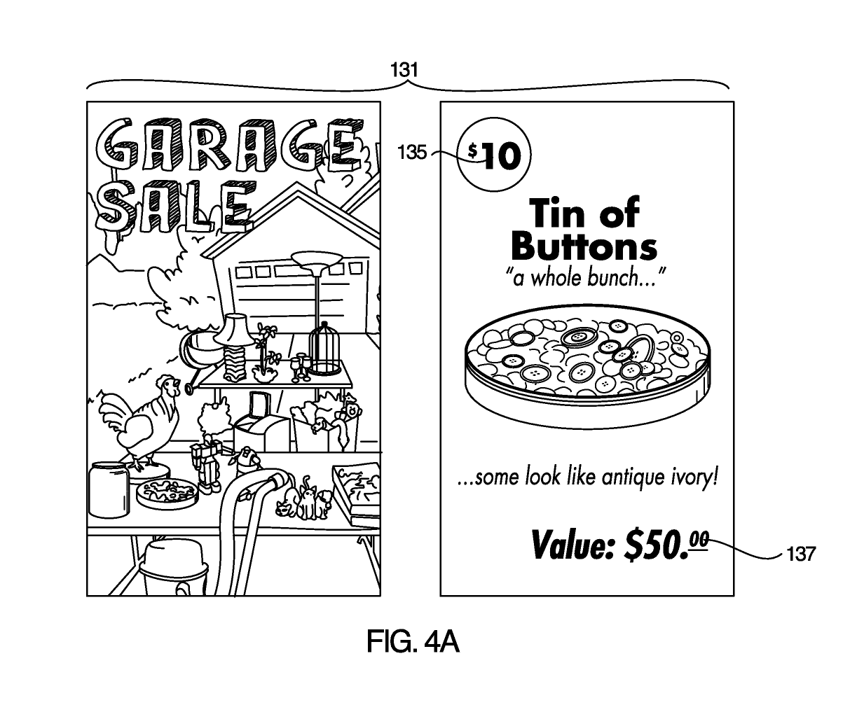

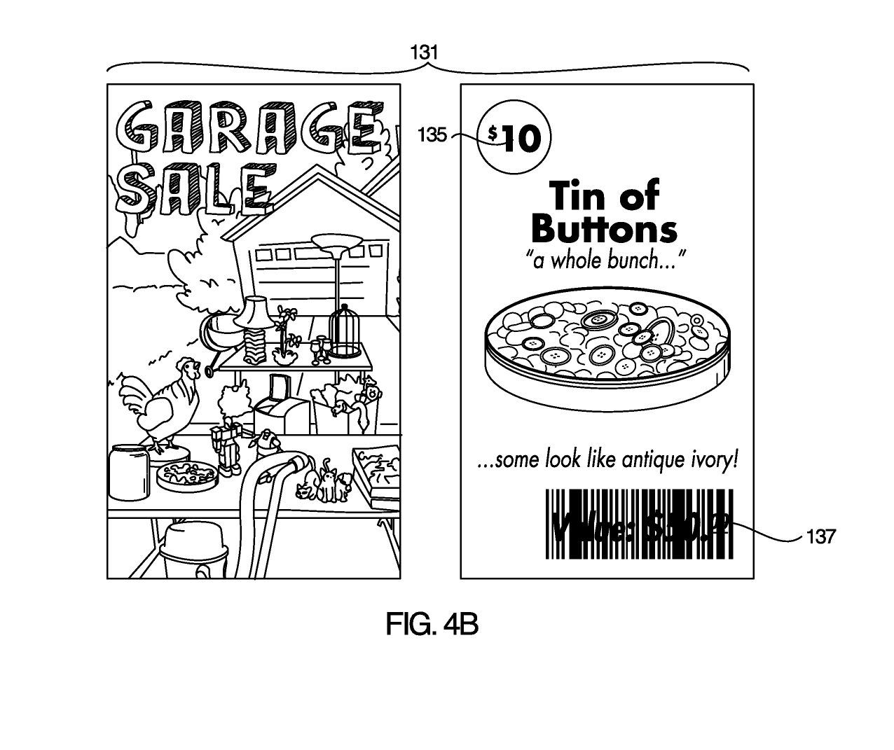

The game board (103) is generally a rectangular and planar surface made from a lightweight but rigid material, with one side depicting a residential neighborhood (107). Generally, the depicted neighborhood (107) includes multiple paths (123)—generally, roads or streets—some of which may terminate at or near an edge of the board (103). The roads (123) are generally segmented into sequences of landable spaces (125) which can accommodate one or more playing tokens (127). The neighborhood (107) also includes a number of residences (109) at which various sales, such as garage and estate sales, are held during game play. A detailed view of a portion of a game board (103) including a residence (109) is depicted in FIG. 2, and a view of an embodiment of a full game board (103) is depicted in FIG. 3. The items for sale at each such residence (109) are the items indicated on Garage Sale cards (131) placed near each residence (109) during gameplay, as elsewhere described herein.

Each residence (109) is generally connected to a space (125) by a driveway. In an embodiment, a residence (109) may be connected to a plurality of spaces (125). In the preferred embodiment, there are ten residences (109), but this amount may vary. Because the number of residences (109) influences the length of game play, the number may be increased or decreased to achieve a desired play duration or play style depending on, among other things, the number of players and the audience. By way of example and not limitation, for a “junior” version of the game targeting younger players with shorter attention spans, there may be fewer residences (109). In a further embodiment, one or more residences (109) may be unused during a game.

In an embodiment, the board (103) further depicts a starting position (117) and an ending position (115). In the preferred embodiment, positions (117 and 115) are the same position, namely a coffee shop or other retail location suitable to the theme and design of the neighborhood. It is specifically contemplated that these and other visual design elements may differ in an embodiment, such as for a version of the game focused on a specific theme, or for localization or regionalization.

The game board (103) may be foldable, allowing the board (103) to be packaged and stored using less shelf space than the surface area of the board (103). Although a generally rectangular board (103) is described herein, other shapes are specifically contemplated, including circular, ovoid, and other polygonal shapes. It is also specifically contemplated that an embodiment of a board may include non-planar shapes or components, including but not limited to a board (103) which has, or can accommodate, three-dimensional structures.

Further, it is specifically contemplated that the board (103) may be configured to facilitate the interconnection of a plurality of boards (103). This may be done by sizing and shaping the edges of a plurality of boards (103) for interlocking, such as with C-cut tabs as in a jigsaw puzzle, or with additional elements to facilitate the mating of a plurality of boards (103), such as a clip to hold the boards (103) in position adjacent to one another.

Generally the player tokens (127) are miniature vehicles, including but not limited to vehicles such as moving trucks, cars, campers, vans, sedans, convertibles, trailers, SUVs, and the like. The tokens are sized and shaped such that a plurality of tokens (127) may fit on spaces (125). In a particular embodiment, the specific design of the tokens (127) may vary depending upon localization, regionalization, or other thematic variations on the game's visual design.

The game currency (111) is a simulated currency, comprising several sets of simulated bank notes or bills in varying denominations. The design and monetary unit of the game currency (111) is generally dollars and/or a dollar sign, but in an embodiment, the design and monetary unit may differ for localization or other changes in theme. The denominations may also differ in an embodiment, such as to reflect local currency denominations. In an embodiment, there are three denominations of notes. In a further embodiment, the three denominations are $20 notes, $10 notes, and $5 notes. During game play, surplus game currency is generally stored in an organizer tray (113) sized and shaped to accommodate the game currency (111). One player designed as a “banker” is responsible for administering the currency (111). This player may also participate in the game (101) as a player but receives no special benefit or advantage for being the banker.

The game includes several decks of cards (129) having different purposes in the game. Each card (129) generally has a distinct image on the back side identifying to which deck the card belongs. The cards (129) may also, in an embodiment, be sized or shaped differently to further distinguish to which deck a card (129) belongs. One of the decks is a deck of Garage Sale cards (131), generally having an indication (133) of an item purchasable at one of the residences, and an indication of a cost (135) and a worth (137) of the item. Generally, the cost (135) indicated is the amount of game currency (111) a player must pay to acquire the card (131), and thus to include the worth (137) of the indicated item towards that player's win total. Values (135 and 137) may differ from embodiment to embodiment, such as to localize values for another currency or accommodate a different theme.

In an embodiment, cost (135) is indicated on Garage Sale cards (131) in color-coded stickers designed to resemble garage sale price stickers, with the color corresponding to a price point. In a further embodiment, these price points are multiples of the lowest denomination of game currency (111). In a still further embodiment, these costs (135) are multiples of five. By way of example and not limitation, items which cost (135) five dollars are coded yellow; ten dollars, blue; fifteen, orange; twenty, green; twenty-five, red. In an embodiment, an alternative victory condition provides for scoring based on these colors, making the game more accessible to younger players and encouraging players to make purchasing decisions based on items they like rather than economic considerations.

Generally, the game (101) is set up by segregating the various types of cards (129) into decks and shuffling each deck. Each player selects one token (127) to represent that player during the game (101), and the tokens (127) representing all players are placed in a starting position (117). A number of cards (131) from the Garage Sale deck are placed face-down next to each of the depicted residences (109). The number of cards (131) placed at each residence (109) generally corresponds to the number of players playing the game (101). For example, if there are four players, each residence (109) receives four Garage Sale cards (131). Generally, the residences (109) are depicted without garages, and the design on the back of the Garage Sale cards (131) is that of a garage, such that when the Garage Sale cards (131) are placed next to the residences (109) on the game board (103), the combination presents the impression of a residence having a garage. Each player also generally receives a “Classified Ads” slip (139) listing the residences (109) having a sale. This slip (139) is used to track the residences (109) at which the player has already purchased an item. Each player also generally receives an amount of initial game currency (111), which amount may vary depending upon the rule set being utilized and/or the number of players participating. In an embodiment, each player receives $100 in game currency (111) to start the game. In a further embodiment, each player receives this currency in the form of three $20 notes, three $10 notes, and two $5 notes.

An object of the game (101) is to navigate one's token (127) to each of the residences (109) and purchase an item at each indicated on a Garage Sale (or, as the case may be, Estate Sale) card (131) at each residence (109) for the amount of game currency (111) indicated on the card (131) as the cost (135) for the item. When a player arrives at a residence (109), the player may privately browse the items for sale at that residence (109) at that time and may, but need not, purchase any one such item. Generally, the player may only purchase from among the items in the Garage Sale cards (131) placed next to the residence (109), but as elsewhere described herein, there are mechanics by which the player may have the opportunity to purchase additional items from the master deck of sale cards. In an embodiment, the player need only disclose the cost of the item purchased to the other players. When the player purchases the item, the player gives to the bank an amount of game currency (111) equal to the Cost (135) of the item indicated on the card (131), and the player receives the card (131) for the purchased item and may count its worth (137) in the player's total for purposes of determining a winner. Other players then cannot purchase that item at that residence (109). In an embodiment, the player need not reveal to other players the worth (137) of the item purchased, nor any special attributes that the item has or bestows upon the player. In a further embodiment, an item may be purchased at a cost other than the indicated cost (135) under certain circumstances including, but not limited to, where the player plays a Haggle card temporarily modifying the game's general mechanics, as elsewhere described herein.

When the player has purchased an item from each of the residences (109) in play, the player then navigates his token (127) to the final position (115). When all players have completed these tasks, the victor is determined by calculating which player's purchases, as reflected on the Garage Sale cards (131) accumulated during the course of play, have the largest total worth of goods purchased. In an embodiment using the Estate Sale cards, the worth of any Estate Sale cards the players has acquired is also included in the calculation.

Generally, on his or her turn a player moves a token (127) representing that player across the playing surface (105) by an amount of spaces (125) equal to a movement amount generated randomly or pseudo-randomly. The movement amount is generally determined randomly using one or more six-sided polyhedral die (141) with the values 1 through 6 indicated upon the sides, as is well known in the art, which the player rolls to determine the maximum number of spaces the player may move the token for that turn. While it generally is anticipated that six-sided polyhedron dice (141) are used, any configuration of die is contemplated, including but not limited to 4-, 6-, 8-, 10-, 12-, and 20-sided dice. In an alternate embodiment, the number of moves is determined through another chance means, such as a spinner or card. Generally, the number of moves for a given turn is randomly or pseudo-randomly determined, and the range of possible values is calibrated to the particular layout off the board (103), with the goal of allowing sufficient movement that gameplay progresses at an entertaining pace, but not so fast that the first few players to move tend to acquire an insurmountable advantage.

In the preferred embodiment, the player generally must move the full amount of spaces (125) rolled by advancing the token (127) along a path (123) without reversing direction. However, the player need not always exhaust the movement amount. By way of example and not limitation, it is specifically contemplated that where a player has sufficient movement to reach a residence (109) or bank (119), the player may conclude the movement portion of his or her turn upon reaching that residence (109) or bank (119) even if further movement remains available.

In an embodiment, the game (101) further includes a deck of Haggle cards (129). In such an embodiment, each player generally is dealt one Haggle card (129) face-down at the beginning of each game, which may be used on a player's turn if the player's token (127) is at a residence (109). A Haggle card (129) may be played on a player's turn if the player is at a residence. The player generally announces his intention to use a Haggle card (129) before beginning to browse the Garage Sale (131) cards at the residence (109), and is thereafter bound by the content of the card. Haggle cards temporarily alter the general game play rules for that player. For example, a Haggle card may allow the player to purchase additional items at the residence (109) during that turn, or may require the player to forfeit the remainder of his turn. Because the player does not know what benefit or burden his Haggle card (129) may impart, whether and when to play a Haggle card is a strategic decision each payer must make.

In an embodiment, the game (101) further includes Bank and/or ATM cards (129) having an indication of an amount of game currency. Generally, the initial currency (111) each player starts with is insufficient for the player to purchase an item at each residence (109), requiring the player to make at least one trip to a bank (119) or a Bank/ATM space (121). When a player arrives at (119 or 121), the player draws a Bank/ATM card (129) and receives the amount of game currency (111) indicated thereon, if any. Although a player must land upon a Bank/ATM space (121) by exact movement count to use the Bank/ATM feature, a player may terminate his turn upon reaching a bank (119) even if the player has not exhausted his movement points.

In another embodiment, the game (101) includes ATM or Bank spaces. These spaces may comprise an indication of a monetary denomination or amount of game currency. When a player lands on an ATM or Bank space, the player receives an amount of game currency equal to the indicated denomination or amount of game currency.

In an embodiment, a residence (109) may be designated as having an estate sale rather than a garage sale, and special estate rules and cards may apply. In such an embodiment, a number of Estate Sale cards are placed next to a residence (109) designed as hosting an estate sale. The number of cards (129) used is generally the same as the number of players. All items purchased at a residence (109) hosting an estate sale generally cost the same amount as each other—such as, by way of example and not limitation, $50 in game currency (111)—and a player cannot browse the items or select which item the player will purchase. Instead, the player must blindly purchase the top item drawn from the Estate Sale cards at that residence. It is generally contemplated that the Estate Sale cards are drawn from a special, separate deck from the Garage Sale cards (131). In an embodiment using the estate sale deck, each player must purchase an estate sale item. It is specifically contemplated that the estate sale may be implemented as a separate board attachable to the main board (103) as elsewhere described herein, such as through an expansion pack.

When a player concludes the movement portion of his or her turn and his or her token (127) lands upon a space already occupied by a token (127) belonging to another player, the player so landing rolls a special six-sided polyhedral die (143) if both players possess at least one Garage Sale card (131). The outcome of this roll (143) may require the players to engage in swapping or taking of one or more of said players' cards (131). For example, in an embodiment the die (143) roll may allow one player to blindly take one card from the another player's hand. Similarly, in a further embodiment, the die roll may require both players to blindly swap cards. The results may or may not be revealed to the rest of the players, depending upon the rule set used. In an embodiment, the die roll may not require any players to swap or take cards.

The game (101) may be expanded using expansion packs. These expansion packs may include the same or similar elements including but not limited to a game board, cards, playing tokens, and additional and further items which alter or augment game play. In an embodiment, an expansion game board (103) is connected to the base game board as elsewhere described herein. In an embodiment, the expansion game board depicts a road so that when the expansion game board is connected to the base game board (103), a path (123) on the base game board (103) continues unto the expansion game board, effectively continuing a road that, without the expansion, is a dead-end on the base game board (103) alone.

In an another embodiment, landable spaces at the edge of the board are not dead-ends, but short-cuts, allowing the player to move or jump the player's token to a corresponding short-cut space. Corresponding spaces may be indicated by a visual cue indicated on the game board, including but not necessarily limited to a particular color of the corresponding spaces.

The game may be augmented, supplemented, or implemented via a computer software application, such as a standalone game or a mobile device application. In one such embodiment, the game includes a mobile device application which can use an optical scanning means, such as an iPhone camera, to scan a bar code on a Garage Sale (131) or other card (129) including but not limited to an Estate Sale card, which provides the player with the worth of the item. In this embodiment, the worth of items may be randomized or otherwise vary from game to game without requiring additional or supplemental decks of cards. In an embodiment, the application also tracks the game progress, such as by tracking a player's point total or progress towards a victory condition, which houses have been visited. In a still further embodiment, cards (131) do not include a worth, and players do not learn the worth of any items purchased until the game concludes, at which point the application reveals the values. In a still further embodiment, special attributes of Garage Sale (131) or Estate Sale cards may be randomized and learned only when the game concludes. In an embodiment, these features are implemented through a web site interface.

In an embodiment, an alternative scoring system is used which disregards item worth (135) and instead awards points towards victory based upon randomly- or pseudorandomly-assigned numeric values associated with a color-coded price point. By way of example and not limitation, all items having a RED price point (i.e., twenty-five dollars) may be worth 10 points towards victory, while all items having a YELLOW price point (i.e., five dollars) may be worth 25 points towards victory. This system adds interest and flexibility for the game to be adapted for play by players who recognize colors but do not yet appreciate the game's economic mechanics. In an embodiment, the point value of items collect tallied towards determining a victory is randomly determined only after all purchases have been made.

In an embodiment, the game is implemented as a playable video game instead of a board game. In one such embodiment, the playable video game is a single-player game and non-human players are controlled by artificial intelligence (“AI”) software. In an alternative embodiment, the playable video game is a multiplayer game. Multiplayer embodiments may also include AI players. By way of example and not limitation, the multiplayer game may be implemented over a network, including but not necessarily limited to the Internet. In such an embodiment, multiple human players use a client to connect over a network to a server to a server hosting an embodiment of a video game implementation of the board game. In a multiplayer embodiment, the gameplay may be generally unchanged or only mildly altered and players compete as described herein until the end of the game is reached and a victory is determined. An example of gameplay and/or rules changes that might be implemented in an embodiment are set forth in Appendix A hereto, the entirety of which is incorporated herein by reference.

In an alternative multiplayer embodiment, certain game rules and/or game play may be altered such that there is no end-game point or victory condition. In such an embodiment, the game comprises a persistent and continuous experience wherein the game state is preserved in real-time whether or not a particular player is playing the game, and updates are provided to players in real-time or near-real-time, similar to multiplayer on-line roleplaying games, such as World of Warcraft®, which are known in the art. In place of a victory condition, a multi-player embodiment may incentivize participation through an advancement or rewards system which provides increasing access to, without limitation, game features, items, customizations, design elements, or other desirable goals as players accumulate wealth, experience, points, or another metric or proxy for assessing or indicating successful or sustained play. An example of gameplay and/or rules changes that might be implemented in an embodiment are set forth in Appendix B hereto, the entirety of which is incorporated herein by reference.

In one such embodiment, a player creates an account and is assigned a virtual residence in a virtual “neighborhood.” The virtual neighborhood shares similar visual and design elements to the game board, comprising a residence, pathways, and other features described herein. Neighborhood may be larger or smaller, or may differ in layout or particular features from that depicted on the game board in the figures. Similarly, neighborhoods may grow as new players join the game. In an embodiment, once a given neighborhood has filled with players/residents, a new neighborhood is created to facilitate additional players. In an embodiment, neighborhoods are connected such that players may travel from one neighborhood to another. Certain neighborhoods may alternatively kept separate, or have prerequisites before they can be accessed. By way of example and not limitation, a neighborhood may be accessible only by residents who have achieved a certain amount of total wealth or experience in the game. Alternatively, a neighborhood may be accessible only by residents who have achieved no more than a certain amount of total wealth or experience in the game, such as “tutorial” neighborhood for new players.

Another manner in which game play may change in an on-line embodiment is in player movement. Whereas the board-game is turn-based, the on-line game may allow simultaneous movement and action by a plurality of players. In an embodiment, player movement is limitless, and players may move any number of squares or spaces they desire at any time. In an alternative embodiment, players are limited in how many spaces they may move at a time by a movement limitation mechanism, which may be a movement limitation means in an embodiment. This mechanism may be a virtual die, which is “rolled” to generates pseudo-random numbers. In an embodiment, players may continually roll the die without waiting for another players' turn to conclude. In an alternative embodiment, players may only roll the die and move at a certain pre-defined frequency. In a still further embodiment, the movement limiting mechanism may comprise a timer. The timer may, for example, allow the player to move only a particular number of spaces within a particular span of time. By way of example and not limitation, a timer may allow a total of 100 spaces of movement within a 30-minute period of real-time. If the player exhausts the allotted spaces, the player must wait for the 30-minute timer to end, at which point the player may move another 100 spaces.

Alternatively, the movement limitation mechanism may be a resource. By way of example and not limitation, the player may be able to pay a fee, rate, or other virtual game currency, or real currency, to gain access to movement within the game. This may be done on any number of bases, including without limitation paying per-space, for a block of spaces, for unlimited movement for a period of time (which may include infinite unlimited movement), or a combination of these or other arrangements. In an alternative embodiment, the player may quickly move a large number of spaces in one movement. For example, the player may hire a virtual “ride,” such as a cab or bus fare, to quickly move a large number of spaces to a predetermined or specified destination, such as by paying for the “ride” with in-game currency and/or real currency. This may be done whether or not the player otherwise has sufficient movement access.

Another manner in which game play may change in an on-line embodiment is in access to in-game currency and resources. Whereas in turn-based play players receive an amount of game currency to spend, the on-line game may be played indefinitely and there is a need for a mechanism for replenishing in-game currency, which may be a currency replenishment means in an embodiment. For example, this mechanism may be an influx of currency provided to a player at an interval, such as a daily bonus. Alternatively, the player may participate in certain activities to gain currency, such as promoting or networking with friends to bring in new players. Alternatively, the player may simply purchase more in-game currency with real currency.

The game play rules may also be altered to provide other mechanism for generating cash, such as by allowing players to sell items they have accumulated. In an embodiment, items may be sold to other players. In a still further embodiment, items may be sold to an automated buyer, such as a pawn shop or antique shop. In such an embodiment, the price paid for items by the antique shop may generally be lower than the price the item fetches on the player market. This feature is generally offered for expediency when a willing purchaser cannot be found or the player simply wishes to be rid of an item, such as where the player cannot otherwise find a willing buyer.

In an embodiment, the on-line game features a mechanism for displaying one's items, which may be an item or merchandise display means in an embodiment. The display mechanism generally displays or causes to be displayed to other players a visual or audiovisual representation of merchandise (also sometimes referred to herein as “items”) owned by the player. This representation may be an icon, an impression, a static image, an animation, and may or may not be accompanied by sound. The display mechanism may be visually represented in the game in any manner suitable to the theme and/or design of the game, the item to be displayed, or of a particular neighborhood. By way of example and not limitation, the display mechanism may be a curio cabinet, display case, shadowbox, bookshelf, or trophy case.

Items associated with the display mechanism may be viewed by other players playing the game under certain circumstances. For example, when a player visits a residence belonging to another player, the visiting player may be able to view items in the display mechanism belonging to the player owning the residence visited. Alternatively, such items may be viewable by other players by simply selecting a residence whose contends the player wishes to view. The display mechanism may also provide information about the item, including but not necessarily limited to: the name of the item, a description of the item, flavor text, the amount paid, where it was acquired, the worth of the item, how long the player has had it, from whom the player acquired it, the item's rarity or drop frequency, an image or depiction of the item, the appraised value of the item, an indication of the appraiser, and other such information. In a still further embodiment, the display mechanism may be used to view items outside of the game, such as on a web site. The visual and/or thematic design of the display mechanism itself (e.g., a curio cabinet) may also vary depending on factors such as the player's tenure in the game, experience level, total worth, the items displayed using the display mechanism, or upgrades acquired or purchased by the player.

In an embodiment, the on-line game comprises an appraisal mechanism, which may be an item or merchandise appraisal means in an embodiment. The appraisal mechanism generally provides a player with an indication of the worth of an item. The appraisal mechanism may provide a precise indication, or a range of possible worths. Alternatively, the appraisal mechanism may vary in accuracy. By way of example and not limitation, the appraisal mechanism may comprise an “antique shop” feature where the player may have an item appraised for free, but the accuracy of the appraisal is unreliable, whereas another appraisal mechanism may comprise a “jewelry dealer” which provides very accurate appraisals but charges for them.

In an embodiment, an appraisal mechanism may be specific to a particular type of item, or may be general. In a still further embodiment, players may have or develop the ability to conduct appraisals and may appraisal items for other players. In one such embodiment, an appraising player is privately provided an appraisal value and/or an range of appraisal values for an item, but may tell the player seeking the appraisal any value the appraising player wishes. This has the advantage of providing an element of social interaction via the appraisal mechanism, and allowing players to develop good (or bad) reputations in the player community for appraisals, mimicking a real-world market. Good and reliable appraisers could charge a premium in game currency for their appraisals. In an alternative embodiment, a player may also be provided an accuracy range for an appraisal done by a player. In a still further embodiment, players may order automated appraisals by paying a fee of real-world currency. The visual and/or thematic design of the appraisal mechanism itself (e.g., an antique shop) may vary from embodiment to embodiment.

The game may be implemented in a client-server architecture, whereby a client application uses a data and/or telecommunications network to access a computer server. The server provides the networked game service and facilitates such tasks as data storage and retrieval, and functions pertaining to a shared game environment, including but not necessarily limited to transmitting to clients updates pertaining to the game state, such as when other players alter the game state, make moves, or the server itself updates or alters the game state. The particular architecture and programming techniques will necessarily depend on design choices and anticipated scale.

In an embodiment, the client is a standalone application. In a further embodiment, the standalone application is an executable program compiled to run natively on a particular computing platform or operating system, including but not necessarily limited to desktop platforms and operating systems (such as but not limited to Windows, Linux, and MacOS), mobile platforms and operating systems (such as but not limited to Windows Mobile, Android, and iOS), console platforms and operating systems (such as but not limited to PlayStation, X-Box, and Nintendo), and hybrid platforms and operating systems. In an embodiment, the client is implemented within an existing development platform or framework. For example, the client may be implemented as a Facebook® game.

It will be understood by one of ordinary skill in the art that the terms “indicator” and “indication” and their variants refer to any means used in the computing arts to provide a visualization, representation, depiction, or reference to an object, including without limitation audiovisual elements such as icons and graphics, and programmatical or data elements such as pointers, references, indices, maps, hashes, and other data structures.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A system for hosting an playable on-line video game simulating competitive treasure hunting comprising:
a computer server communicating with a client device over a network and comprising:
a processor;
a tangible non-transitory computer-readable storage medium having computer-readable instructions which, when executed by said processor, cause said computer server to provide on said network a service implementing a plurality of game elements which, together, comprise an on-line, persistent, multiplayer competitive treasure hunting video game, said plurality of game elements comprising:
a plurality of player position tokens;
a game board comprising:
a plurality of paths divided into a plurality of landable spaces;
a plurality of purchasing locations each connected to one of said landable spaces;
a plurality of merchandise indicators having and associated merchandise purchasable at one of said plurality of purchasing locations associated with said indicator when said game is played and an associated cost of said merchandise and an associated worth of said merchandise;
an in-game currency;
a movement limitation mechanism;
a merchandise display mechanism;
a merchandise appraisal mechanism;
a reward system incentivizing players playing said board game to acquire a plurality of said plurality of merchandise cards such that the player maximizes the total amount of worth indicated on said plurality of said plurality of merchandise cards acquired by said player;
when a plurality of players play said game, a plurality of said plurality of merchandise cards corresponding in number to the plurality of players is associated with each one of said purchasing locations; and
when each player in said plurality of players advances one of said player tokens corresponding to said each player to a purchasing location in said plurality of purchasing locations, said each player may exchange for one of said plurality of said plurality of merchandise cards placed associated with said each purchasing location an amount of said game currency held by said each player equal to said cost of said merchandise indicated on said one of said plurality of said plurality of merchandise cards associated with said each purchasing location.

2. The system of claim 1, wherein said associated cost of said merchandise is a pseudo-randomly generated value.

3. The system of claim 1, wherein said associated cost of said merchandise is a pre-determined value.

4. The system of claim 1, wherein said associated worth of said merchandise is a pseudo-randomly generated value.

5. The system of claim 1, wherein said associated worth of said merchandise is a pre-determined value.

6. A method for implementing an on-line, multiplayer, persistent video game on a computer server having a processor and a tangible, non-transitory computer-readable storage medium and the capability of communicating with a client device, said method comprising the steps of:
providing a plurality of player position tokens;
providing a game board including:
a plurality of roads divided into a plurality of landable spaces;
a plurality of residences each connected to one of said landable spaces;
providing a plurality of merchandise indicators having and associated merchandise purchasable at one of said plurality of residences associated with said indicator when said game is played and an associated cost of said merchandise and an associated worth of said merchandise;
providing a game currency;
providing a pseudorandom number generator;
providing a plurality of players;
providing a reward system;
providing a merchandise display mechanism;
providing a merchandise appraisal mechanism;
each player in said plurality of players moving a player position token representing said each player a number of said landable spaces corresponding to a pseudorandom numeric value determined using said pseudorandom number generator until said player position token is at one of said plurality of residences;
appraising a merchandise with said merchandise appraisal mechanism;
display a merchandise with said merchandise display mechanism;
when said player position token is at said one of said plurality of residences, said each player exchanging for one of said plurality of merchandise cards disposed at said one of said plurality of residences an amount of said game currency held by said each player equal to said cost indicated on said one of said plurality of merchandise cards;
said reward system incentivizing said players playing said game to acquire a plurality of said plurality of merchandise cards such that the player maximizes the total amount of worth indicated on said plurality of said plurality of merchandise cards acquired by said player.

7. The method of claim 6, wherein said associated cost of said merchandise is a pseudo-randomly generated value.

8. The method of claim 6, wherein said associated cost of said merchandise is a pre-determined value.

9. The method of claim 6, wherein said associated worth of said merchandise is a pseudo-randomly generated value.

10. The method of claim 6, wherein said associated worth of said merchandise is a pre-determined value.
